(19) United States
(12) Patent Application Publication
(10) Pub. No.: US 2002/0083630 A1
(43) Pub. Date: Jul. 4, 2002

(54) Conditionally adjusted speed limit for roads

(76) Inventor: Robert Victor Marcon, Niagara Falls (CA)

Correspondence Address: ROBERT V. MARCON, 3471 SINNICKS AVENUE, NIAGARA FALLS, ON, L2J 2G6, CA

(21) Appl. No.: 09/990,826

(22) Filed: Nov. 13, 2001

Related U.S. Application Data
(60) Provisional application No. 60/312,797, filed on Aug. 17, 2001.
(60) Provisional application No. 60/248,074, filed on Nov. 14, 2000.

(51) Int. Cl. G09F 1/00

(52) U.S. Cl. 40/612

(57) ABSTRACT

The invention detailed herein provides for a new method of improving the vehicular capacity of a conventional road by utilizing at least one conditionally adjusted speed (CAS) limit who's adjustment is based upon at least one seasonal and/or situational parameter or guideline. Moreover, the implemental rapidity of CAS limits is also superior to most solutions presently under consideration because their integration into existing traffic control systems does not create any appreciable technological, implemental or legal difficulties. This method therefore, not only improves the overall vehicular capacity of conventional roads but does so without increasing either driver or governmental costs. Reductions in the use of fuel and land as well as diminishing the overall travel times, accident rates, and emissive pollution associated with vehicular transportation are other distinct benefits also provided by this method.

### BACKGROUND OF THE INVENTION

This invention relates to roads and their speed limits. More particularly, it relates to the use of one or more seasonally and/or situationally adjusted speed limits on said roads in order to improve their vehicular capacity.

In today's world, there is currently an extreme need to improve the vehicular capacity of many roads and highways without increasing road size. There is also a growing desire to not only improve road safety but reduce travelling time and vehicular emissions as well. However, these objectives, while admirable, have not yet been fully realized even though many approaches have been investigated, studied and tried. For example, certain jurisdictions, in order to improve traffic flow, have implemented special lanes allocated specifically to vehicles carrying two, three or more passengers. Unfortunately, this strategy, while augmenting a road's ability to handle increased passenger volumes, does not actually improve its ability to handle increased vehicular volumes. Moreover, this strategy also suffers significant logistical problems due to the diverse origins and destinations of passengers.

In contrast, other jurisdictions have introduced specially designated toll lanes and roads in order to allow people to drive in relatively low density traffic. California, for instance, uses electronically controlled toll lanes where tolls go up according to traffic volumes. People who cannot afford the delay pay more to go faster. Although this technique has accomplished the objective of reducing traffic density, it is expensive and so has not experienced any widespread use. More importantly however, it fundamentally lacks the ability to increase the vehicular capacity of roads.

Yet another area of traffic management experiencing intense study is the field of wireless technology. In fact, the first North American prototype demonstration of such a system was given north of San Diego on a twelve kilometer stretch of California's Interstate 15. One lane, which was being used for car pooling during rush hour, was equipped with eight-centimeter-long magnetic spikes that were buried in the road. These spikes, in conjunction with vehicular on-board computers, allowed the distance between vehicles to be safely controlled. As a result, these vehicles were now able to travel in much tighter groups while still maintaining a high rate of speed.

What the San Diego project and others like it in Europe and Japan have therefore demonstrated is that this particular type of technology, if perfected, will be able to substantially raise the vehicular capacity of a road without increasing risk. Sadly, some big questions remain unanswered. Will people trust a computer to drive their cars? Who would be liable if a computer fails and there is an accident? Could this lead to an invasion of privacy because cars equipped with such computers could be traceable?

Consequently, it must therefore be concluded that while these types of technologies show great promise, they must be considered for the time being experimental, costly, and legally controversial. However, it is hoped by those involved, that this technology may some day increase a road's vehicular capacity by a factor of two.

In still other locales, various other technologies are also being tested. One such system, for example, uses computerized traffic signals to adjust for traffic volume and conditions. It does this by adjusting traffic light patterns according to electronic signals received from sensors imbedded within the road. In another system, changeable electronic messaging displays are used to inform motorists about oncoming traffic jams, collisions, or road closures as well as provide messages of possible alternate routes. In yet another example, Buick has demonstrated a concept car which utilizes an on board navigational system to indicate vehicular direction on a map. Moreover, the distance, time to destination, road names, the colour of approaching traffic lights, as well as emergency vehicle warnings can also be relayed to the driver. Mercedes-Benz, in contrast, is developing an autonomous intelligent cruise control that can maintain proper safety margins between a driver's car and the one ahead of it. If the car gets too close, the system reduces fuel to the engine and applies the brakes if necessary.

In the final analysis however, finding better ways to safely increase the vehicular capacity of a road is what all transportation experts try to achieve. Unfortunately, various impediments to this goal have proven very difficult to overcome. For instance, it has been found that while congestion can be caused by a number of individual or combinational circumstances the greatest overriding factor was vehicular volume versus road capacity. Using information derived from computer models as well as real life experiences these experts have discovered that as traffic builds the average speed drops gradually until the road or highway reaches a critical point. That point is the traffic abyss, so to speak, for if a few more vehicles are put on the road it will fall into an unstable region where speed drops dramatically and soon everyone is stuck in stop-and-go traffic. Moreover, as traffic congests accidents increase and for every one hundred direct accidents, twenty secondary ones will occur.

Traffic studies have also discovered that if one lane of a three lane road is closed capacity drops not by a third but by half. Shoulder blockages, on the other hand, could reduce capacity by eighty-four percent. Both of these phenomenons can be directly attributed to the vehicular friction caused when cars and trucks are squeezed from three to two lanes and by people who slow down to see what's going on. Consequently, for each minute that a stalled car or accident blocks a lane five minutes of congestion follows but for each minute that a road is blocked at least ten minutes of congestion ensues. As a result, even if a road is blocked for only fifteen minutes, motorists may still feel the effects almost two and a half hours later.

Although some solutions may ultimately provide a means of increasing vehicular capacity costs will undoubtedly be high. These thoughts have also been expounded by the Intelligent Transportation Society of America which has forecast a total U.S. market for intelligent transport systems at 420 billion dollars U.S. over the next twenty years. They have also stated that 340 billion of this amount would be spent by motorists on private solutions such as in-car navigational devices with the balance going to public networks.

While it is generally admitted by all that these costs are high, the cost of doing nothing, is greater still. For instance, it has been reckoned that Americans alone waste an estimated two billion hours a year delayed in traffic jams. American businesses also suffer heavily as the annual cost of traffic congestion has been approximated to be at least 40 billion dollars U.S. If the costs of wasted fuel, emissive pollution, accidents, medical costs, and deaths are also factored in, the final price is staggering.

Consequently, there still remains a huge unfulfilled need to improve this situation at an affordable cost. To this end, the inventor has created a new method of improving the vehicular capacity of roads without the need to charge tolls or significantly expand construction budgets. In addition, this new method also produces a number of other benefits such as decreasing the overall use and quantity of fuel and land, as well as reducing vehicular travel times, accident rates, and engine emissions.

### OBJECTS AND ADVANTAGES

While this new method of conditionally adjusting speed limits overcomes many of the drawbacks listed in the prior art it also provides a number of other important benefits. As such, some of the objects and advantages associated with this new method are described below. Others will become apparent as the description proceeds.

Objects:

(1) To improve the overall vehicular capacity of conventional roads.

(2) To improve overall driving safety.

(3) To reduce overall vehicular emissions by controlling vehicular speed and/or use.

(4) To help reduce or control the already high cost of vehicular transportation.

Advantages:

(1) By utilizing at least one conditionally adjusted speed limit overall vehicular capacity can be significantly increased thereby reducing the need to build new roads or infrastructure. In turn, this should also lower the overall land requirements needed for the national road system.

(2) Funds that would needlessly go to the construction of new roads and infrastructure could be utilized in other more worthwhile projects.

(3) By optimizing overall traffic flows, vehicular travel times, accident rates, and exhaust emissions are also reduced.

(4) Reductions in overall travel times, accident rates, and exhaust emissions, in turn, also provide substantial savings in both business and medical costs.

(5) Whenever traffic flows are well ordered, the tension and frustrations levels that drivers normally experience, diminish.

(6) In some cities, daily atmospheric pollution or smog has now reached a point where local authorities are sometimes forced to issue smog alerts and/or restrict vehicular traffic. However, if the speed limits of various roadways, highways, expressways or thoroughfares were lowered and/or certain high polluting vehicles restricted at such times, vehicular emissions could be considerably reduced. In turn, this would give officials the ability to optimize smog levels and/or vehicular capacity, as need be.

(7) The implementation time required to fully utilize this new method is significantly faster than most solutions presently under consideration.

(8) The integration of conditionally adjusted speed limits into existing traffic control systems is not hindered by any appreciable technological, implemental or legal difficulties.

### SUMMARY OF THE INVENTION

The invention detailed herein provides for a new method of improving the vehicular capacity of conventional roads by utilizing at least one conditionally adjusted speed (CAS) limit who's adjustment is based upon at least one seasonal and/or situational parameter or guideline.

Some seasonal guidelines can include, but are not limited to, those time periods or portions thereof such as, spring, summer, autumn, winter, Daylight Savings Time, and various holiday seasons, alone or in combination. In contrast, situational guidelines may include, but are not limited to, various unusual, unexpected or dangerous situations like time of day, smog alerts, high density vehicular traffic, vehicular accidents, poor roadway conditions, high winds, rain, flash floods, fog, fire, ice, hail, sleet, snow, blowing snow, as well as evacuations ordered by various governmental authorities, police, firefighting, and medical personnel, alone or in combination.

Various means may also be employed to communicate such CAS limits to the driving population some of which include, but are not limited to, the use of one or more legislatively adjusted speed limits, modified speed limit signs, lane speed limit signs, electronic speed limit signs, and multiple speed limit signs, alone or in combination. In addition, the integration of CAS limits, into existing traffic control systems, is much easier than most solutions presently under consideration because they neither create nor are hindered by any appreciable technological, implemental or legal difficulties. Rather they should readily blend into most existing systems, procedures, and laws be they federal, state, provincial or county, without incident.

This method therefore, not only improves the overall vehicular capacity of a road but does so without increasing either driver or governmental costs. Notable reductions in both the use of fuel and land are also possible as is diminishing the overall travel times, accident rates, and emissive pollution associated with vehicular transportation. As such, the overall merits of this method are substantial, and should therefore incite considerable interest from those responsible.

### BRIEF DESCRIPTION OF THE DRAWINGS

Not Applicable.

### DETAILED DESCRIPTION OF THE INVENTION

The following description is provided to enable any person skilled in the art to use the invention herein disclosed. Various modifications, however, will remain readily apparent to those skilled in the art, since the generic principles of the present invention have been defined herein specifically to provide for the description of a conditionally adjusted speed (CAS) limit for roads.

Moreover, said CAS limit shall also be understood to be a means of further improving the overall vehicular capacity of a conventional road by seasonally and/or situationally adjusting at least one of the speed limits of said conventional road or lane(s) therein, either higher or lower, in order to more suitably accommodate or control anticipated and/or actual vehicular driving conditions. As such, any road utilizing unadjustable speed limits and signs thereof, be they city or highway, shall be herein defined as a conventional road but any road employing a CAS limit shall be herein defined as a roadway. Also note, that the term “lane” is herein understood to include any regular or normal lane that is part of a road, roadway, highway, expressway or thoroughfare, as well as any paved or otherwise useable shoulders abutting or adjoining such lanes. In addition, the words “vehicular capacity”, shall be used herein as a reference to that number of vehicles which a road or roadway may safely handle during a quantitative or specific period of time. Lastly, CAS limits are, for the purpose of this disclosure, to be used only on roads which are considered to be, fully operational. Thus, a fully operational road is herein defined as any road, conventional road, roadway or portion thereof, which is not under construction or damaged so as to be made unusable for their intended task.

That said, the disclosure will now carefully detail the main purpose of CAS limits, which is, to optimize vehicular capacity. Although a number of techniques can be used, the principal means used by all CAS limits in achieving this goal will include at least one of the following two parameters.

(1) Seasonal adjustments to at least one speed limit.

(a) The definition of a seasonal adjustment shall herein refer to all such times which encompass or include seasonal time frames, and approximations thereof, alone or in combination.

(2) Situational adjustments to at least one speed limit.

(a) The definition of a situational adjustment shall herein refer to all such times which encompass or include, but are not limited to, unusual, unexpected or dangerous situations like time of day, smog alerts, high density vehicular traffic, vehicular accidents, poor roadway conditions, high winds, rain, flash floods, fog, fire, ice, hail, sleet, snow, blowing snow, as well as evacuations ordered by various governmental authorities, police, firefighting, and medical personnel, alone or in combination.

As a result, it becomes readily apparent that there are three possible scenarios which can provide many significant benefits. The first of these is seasonal. The second is related to situational circumstances and the last is but a logical combination of these two preceding independent parameters. In all cases, speed limits could be raised during those periods of time when driving conditions are at their best, and lowered when they are at their worst. This thus offers, any jurisdiction utilizing such a method, rapid implementation, significantly increased traffic flows, and diminished travelling times with little or no additional cost to either drivers or governments. Moreover, as travel times are reduced, fuel consumption and exhaust emissions are generally also reduced. It is also widely known that as traffic congestion rises accident rates and frustration levels (“Road Rage”) also rise. Thus, as traffic congestion is diminished or is better controlled the frequency of these events also declines.

By definition, CAS limits which are seasonally set can include those time periods or portions thereof such as spring, summer, autumn, and winter, alone or in combination. One illustration which uses such guidelines begins by first analyzing which seasons of the year offer the best driving conditions. In areas located in the northern hemisphere, those time periods would generally begin somewhere in March and end thereabouts in November. In the southern hemisphere, those time periods would normally start in September and end somewhere in May. Once established, new conditionally adjusted high and/or low speed limits could then be used within these intervals in order to safely optimize vehicular capacity.

In light of this analogy, legislators could also utilize that part of the year commonly known as Daylight Savings Time as it offers many of the above advantages. For example, it is well recognized by the general public and so easily remembered. Secondly, time adjusted intervals are congruent with speed adjusted intervals. That is, both time and speed would spring ahead in spring and fall back in fall. Thirdly, weather conditions during this time period are normally very good and fourthly, daylight hours are at their maximum. As a result, higher speeds could be allowed without undue risk because driving conditions would be at their best.

However, it must also be remember that while selectively increasing the speed limit of a roadway offers many advantages these advantages may not be fully realized if people persist in driving too slowly, especially on major highways. Therefore, an appropriate course of action would be to legislate that the minimum speed limit be respectively raised or lowered whenever the maximum limit is raised or lowered. Thus, by way of example and not limitation minimum speed limits could be legislatively set fifteen miles per hour or twenty-five kilometres per hour less than the authorized maximum. Yet another method of approach would be to legislate that the maximum speed limit permitted during a roadway's slow or unadjusted period be used as its minimum speed limit during its fast or adjusted period. In this way high speed travellers would not be impeded by slower moving vehicles thereby maintaining the overall efficiency of the system at a high level.

Seasonally set parameters may also include holidays in which drunk driving has been a known and ongoing concern. Although there are understandably many holiday seasons from which to choose, some of which are indigenous to certain nations, religions, or peoples, one suitable and well recognized period would be the Christmas holiday season. It is a season which begins with Thanksgiving and ends, thereabouts, on the second of January the following year. It must also be understood that this holiday season need not comprise the entire interval but may, when convenient, include any portion or portions thereof. Thus, with this in mind, speed limits could be adjusted lower in order to reduce accidents during these, and other such holiday periods.

Although these methods can be used in a wide variety of circumstances the speed limit signs themselves need not change. This not only saves a substantial amount of money but reduces implementation time as well. As a result, these methods and others like them which use conventional speed limit signs shall be herein referred to as legislatively adjusted speed limits.

Additional Features

The disclosure has so far dealt with the basic concepts of CAS limits. These innovative concepts are of course directed to increasing the overall vehicular capacity of many existing as well as future roads. There is, however, a number of additional features which may be incorporated into the basic method which could, in most cases, improve its implementation or overall performance. Of course, each modification or combination has its own particular merits and thus should only be utilized in accordance with any particular performance, cost, safety or technical requirements envisioned. It should also be understood that the modifications detailed below show some, but not all, of the possible variations conceivable.

Modification Number One

In conventional practice, a speed limit sign will post only one maximum speed limit. However, one modification of this method would be to use only one sign but display two speed limits or to use two signs which display one speed limit each. Such signs, which are herein referred to as modified speed limit signs, can be used to indicate a roadway that is regulated by at least one CAS limit. That is to say, that one or both of these two speed limits can be adjusted either seasonally and/or situationally in order to improve vehicular capacity. Different sized letters, words, phrases, numbers, symbols, colours, signs as well as their positioning and arrangement upon the signs themselves can be used, alone or in combination, in order to indicate or designate which speed limits are adjusted and which are not.

Moreover, and in a fashion similar to that discussed above, signs displaying two speed limits can also be used to indicate not only the highest but also the lowest speed limit permitted on a roadway. They could also be used to provide speed limit regulation by vehicular class or passenger count. Thus, for example, unadjusted speed limits during slow periods could be used to control or regulate both light and heavy vehicles. During adjusted or fast periods, however, light vehicles would be authorized or allowed to accelerate to the higher adjusted speed limits whereas heavy vehicles would be required to remain at their original slower speeds. This same scenario could also be applied to motorcycles, automobiles or light truck in order to allow vehicles carrying, for example, two or more people to travel faster than those carrying only one. These types of signs, which are herein called vehicular restricted modified speed limit signs, are but a simple variation or sub-group of the main category of modified speed limit signs and so shall be herein classed as such.

Modification Number Two

When roadway speed limit signs use CAS limits to specifically control the individual lanes of a roadway they shall be herein classified as lane speed limit signs. Such signs, in order to more clearly expose them to oncoming motorists, can also be posted either overhead or near a roadway's shoulder. They could also be worded, numbered, inscribed, depicted, coloured or framed in an otherwise different manner than conventional signs so as to be quickly and easily differentiated by drivers. Arrows can also be used on such signs to directly indicate which lanes are governed by various CAS limits.

Using this technique will therefore allow those drivers desiring slower or unaltered speeds to continue to do so in the appropriately designated lanes. It will also allow those drivers wishing to make use of higher speeds the chance to do so without interference from slower moving vehicles.

Modification Number Three (a)

Yet another possible strategy that would increase the overall flow of traffic would be the adoption of one or more electronic speed limit signs that utilize at least one CAS limit. These signs, which are basically similar or identical to the changeable electronic messaging displays currently used on many of today's conventional roads and highways, offer motorists one of the best possible means of roadway speed management. That is because these types of displays can be quickly updated in a real time manner, and so used to precisely control and therefore optimize, the flow of traffic. For example, by electronically increasing an existing speed limit when conditions are good the possibility of future traffic congestion is significantly diminished. Conversely, speed limits can also be quickly lowered, in a controlled fashion, should the situation change for the worse. In both cases, the primary goal of optimizing vehicular capacity is much more likely to be achieved.

As such, an electronic speed limit sign may therefore comprise a changeable electronic messaging display that is manually or automatically controlled by the use of at least one computer, using one or more telephones, cellular telephones, radios, microwave devices, internet devices, satellites, and other electric, and electronic communications, alone or in combination. If existing road or highway displays are also used—lower costs, quicker implementation, and greater public acceptance are also achieved.

Computers employed in such signs may also be used in a number of different ways. They may, for example, be made to function as individual units dedicated to the operation of just one electronic speed limit sign. They may also, however, work in concert with various other computers and devices in order to govern large integrated urban, state or national networks.

Electronic speed limit signs can also be powered in a relatively straight forward manner by means which include, but are not limited to, power provided by at least one electric power utility, portable electrical generator, fuel cell, battery, or array of photovoltaic solar cells, alone or in combination.

That said, electronic speed limit signs may yet again, be improved in a variety of different ways. For example, they could, in addition to posting one or more speed limits, be used to relay a variety of other information to drivers which can include, but is not limited to, words, phrases, numbers, pictorial representations, vehicular restrictions, traffic conditions, traffic accidents, roadway conditions, smog levels, weather conditions, alternate routes, geographical information, advertising, and slogans, alone or in combination. They could also be individually posted on one, some or on all roadway lanes, by locating them overhead or near an adjoining shoulder. Electronic speed limit signs could even be made large enough to singly span a roadway's entire width. By doing this, a high degree of flexibility, individual control as well as operational safety is achieved.

Regulations could also be enacted stating that should letters, words or other representations such as XXX, OOO, zero, closed, and/or a diagrammatic arrow appear in place of a speed limit, then all lanes governed by that speed limit shall be considered closed to all but emergency vehicles. Such exclusionary messages may also employ one or more different colours and in formats that are continuous or flashing. As for diagrammatic arrows—they are used to inform or show drivers which lanes are currently closed or closing as well as directing or pointing them to lanes that are currently open. As such, they can be one or two headed since open lanes could be located to the right and/or left of a driver.

In any event, prohibitory messages such as these shall be herein referred to as exclusionary messages. Their purpose is to help motorists quickly adjust to various situations thereby reducing accidents, congestion, and the time needed to fully resume normal traffic flows.

Modification Number Three (b)

While most roads and highways do not have specific vehicular restrictions, some do. As a result, there may be certain situations where it is advantageous to increase or decrease the speed limit of certain vehicular classes such as heavy trucks, buses and other large transports. The control of such vehicles, however, can be carried out in a number of ways, one of which includes, utilizing an electronic speed limit sign displaying two speed limits. Thus, one speed limit could be directed to motorcycles, automobiles, and light trucks while the other could be respectively directed to heavy trucks, buses, and other such vehicles. A simple word such as “cars” or other suitable pictorial representation thereof could also be used above or beside the appropriate speed limits in order to inform drivers that these limits are directed to light weight vehicles. Likewise, a word such as “trucks” or other suitable pictorial representation thereof could also be used above or beside the other limit, for similar reasons. In addition, the use of lane electronic speed limit signs on some, most or all of a roadway's individual lanes will further improve the ability of officials to control traffic in this manner.

As mentioned before, regulations could also be enacted stating that should letters, words, phrases or representations such as XXX, zero, closed or a diagrammatic arrow or other appropriate expression appear in place of a speed limit then that lane is not to be used by vehicles normally controlled by that speed limit. Consequently, whenever such communications are used they shall be herein referred to as class exclusionary messages and shall apply to all but emergency vehicles.

As a result, an electronic speed limit sign, by being able to display at least one CAS limit and class exclusionary messages, provides one of the best overall systems of roadway management possible.

Modification Number Three (c)

In addition to the above, the performance of electronic speed limit signs may yet be further enhanced if certain specialized pieces of equipment, sensors or devices are also used. These may include, but are not limited to, the use of one or more vehicular sensing, vehicular counting, vehicular tolling, temperature sensing, wind measuring, precipitation sensing, light sensing, smog sensing, and camera devices, alone or in combination. These items, when embedded within a roadway, placed upon its surface or perched upon a sign, pole or tower, in accordance with their individual functions, will be able to continuously feed information directly to the computers controlling individual electronic speed limit signs and/or central traffic command centres. This information, once received by the appropriate computers, can then be acted upon in an automatic, semi-automatic or manual manner by various supervisory or other authorized personnel.

Thus, for example, normal or higher speed limits could be used whenever conditions are good and lowered whenever unusual, unexpected or dangerous situations like time of day, smog alerts, high density vehicular traffic, vehicular accidents, poor roadway conditions, high winds, rain, flash floods, fog, fire, ice, hail, sleet, snow, blowing snow, as well as evacuations ordered by various governmental authorities, police, firefighting, or medical personnel are experienced, alone or in combination. When such situations manifest themselves and prudence dictates, a preemptive or planned reduction in vehicular speed effectually produces a more ordered flow of traffic than would have otherwise been possible. Consequently, this helps to maintain the speed of traffic at an overall higher level thereby maximizing vehicular capacity and safety accordingly.

In yet another example, situational adjustments may be effectively used in cities experiencing high smog levels. In such cities, authorities have sometimes even been forced to not only issue smog alerts but restrict vehicular traffic as well. However, if the speed limits of various roadways, highways, expressways or thoroughfares were lowered and/or certain high polluting vehicles restricted during such times, vehicular emissions could be considerably reduced. That is because, lowering overall vehicular speed lowers overall engine emissions and restricting certain vehicles by factors which may include, but are not limited to, class, age, engine design, output horsepower, size, type, weight, license plate number, vehicle origin, profit or non-profit, and time of day, alone or in combination can produce disproportionate decreases in the amount of emissive pollution generated. Age and time of day restrictions are particularly useful because older vehicles emit substantially more pollution than newer models and daylight hours are known to create greater quantities of photochemical smog. Their use therefore provides officials with an improved ability to optimize both smog levels and/or vehicular capacity, as need be. In cases such as these, all such restrictions are herein referred to as emissive exclusionary messages.

In conclusion, these diverse and important sources of information therefore enable electronic speed limit signs to quickly react to various traffic, weather, atmospheric or emergency situations. In turn, this allows the flow of traffic to be regulated to a much greater degree thereby boosting the system's overall efficiency, safety, and control to a level, unparalleled by any method currently available.

Modification Number Four

While the method disclosed herein has generally dealt with two speed limits that is not the only option available. Rather, should officials desire yet greater flexibility, speed limit signs could be altered to include at least three speed limits, one or more of which, being also designated a CAS limit. Such signs, for the purpose of this disclosure, shall be herein referred to as multiple speed limit signs.

As previously remarked, one or more of these conventional or conditionally adjusted speed limits may also be restricted to certain vehicular classes. When this happens, such signs are herein called vehicular restricted multiple speed limit signs. It should also be understood that these signs are but a simple subgroup of the main classification known as multiple speed limit signs.

Finally, in order to improve effectiveness within this classification yet again, different sized letters, words, phrases, numbers, symbols, colours, signs as well as their positioning and arrangement upon the signs themselves can be used, alone or in combination, to differentiate various speed limits and/or signs.

Closing Thoughts

The many benefits afforded by CAS limits are both innovative and highly desirable. Moreover, these benefits, some of which are listed below, not only increase vehicular capacity and roadway safety but reduce travelling time, vehicular emissions, and costs as well.

(1) By utilizing at least one conditionally adjusted speed limit overall vehicular capacity can be significantly increased thereby reducing the need to build new roads or infrastructure. In turn, this should also lower the overall land requirements needed for the national road system.

(2) Funds that would needlessly go to the construction of new roads and infrastructure could be utilized in other more worthwhile projects.

(3) By optimizing overall traffic flows, vehicular travel times, accident rates, and exhaust emissions are also reduced.

(4) Reductions in overall travel times, accident rates, and exhaust emissions, in turn, also provide substantial savings in both business and medical costs.

(5) Whenever traffic flows are well ordered, the tension and frustrations levels that drivers normally experience, diminish.

(6) In some cities, daily atmospheric pollution or smog has now reached a point where local authorities are sometimes forced to issue smog alerts and/or restrict vehicular traffic. However, if the speed limits of various roadways, highways, expressways or thoroughfares were lowered and/or certain high polluting vehicles restricted at such times, vehicular emissions could be considerably reduced. In turn, this would give officials the ability to optimize smog levels and/or vehicular capacity, as need be.

(7) The implementation time required to fully utilize this new method is significantly faster than most solutions presently under consideration.

(8) The integration of conditionally adjusted speed limits into existing traffic control systems is not hindered by any appreciable technological, implemental or legal difficulties.

Addendum

Further information and literature on the subject of traffic management, road construction as well as other information relating to the disclosure herein, can be found in the many books available to the public at libraries, technical centres, and patent depositories. In addition, the following references, the entire contents of which are hereby incorporated by reference into this specification, will also provide a range of detailed information that can be used to further elaborate and explain the teachings herein provided by this disclosure.

| | | |
|---|---|---|
| (1) | Title: | Traffic Engineering Handbook, 5th Edition |
| | Author: | James L Pline (Editor) |
| | Publisher: | Institute of Transportation Engineers |
| | Copyright: | 1999 |
| | ISBN: | 0935403329 |
| (2) | Title: | Handbook of Road Technology: |
| | | Traffic and Transport, 3rd Edition |
| | Author: | M. G. Lay |
| | Publisher: | Gordon & Breach Science Pub. |
| | Copyright: | 1999 |
| | ISBN: | 9056991582 |
| (3) | Title: | Highway Design and Traffic Safety Engineering |
| | | Handbook |
| | Author: | Ruediger Lamm, Basil Psarianos, and Theodor |
| | | Mailaender |
| | Publisher: | McGraw-Hill Professional Publishing |
| | Copyright: | 1999 |
| | ISBN: | 0070382956 |
| (4) | Title: | Speed kills? |
| | | Not as much as the feds claim. |
| | Author: | Patrick Bedard. |
| | Publisher: | U.S.A. Today, |
| | | Editorial and Publication Headquarters, |
| | | 1000 Wilson Boulevard, |
| | | Arlington, Virginia, |
| | | U.S.A., |
| | | 22229. |
| | Copyright: | Newspaper excerpt printed September 24, 1996 |

In conclusion, the reader must also understand that the preceding description contains many specificities that should not be construed as limiting the scope of the invention but as merely providing illustrations of some of the presently preferred embodiments thereof. As a result, the scope of the invention should thus be determined by the appended claims and their legal equivalents, rather than the examples given.

The embodiments of the invention in which an exclusive property or privilege is claimed are defined as follows:

1. A method of increasing the overall vehicular capacity of a conventional road comprising the utilization of at least one conditionally adjusted speed limit wherein said conditionally adjusted speed limit is used to control the speed limit of at least one lane of said conventional road so as to thereby create a roadway.

2. The method of claim 1 wherein said conditionally adjusted speed limit utilizes at least one seasonal adjustment or situational adjustment, alone or in combination.

3. The method of claim 2 wherein said seasonal adjustment is selected from the group consisting of all or part of the time periods known as spring, summer, autumn, winter, Daylight Savings Time, and the Christmas holiday season, alone or in combination, and wherein said situational adjustment is selected from the group consisting of time of day, smog alerts, high density vehicular traffic, vehicular accidents, poor roadway conditions, high winds, rain, flash floods, fog, fire, ice, hail, sleet, snow, blowing snow, and evacuations, alone or in combination.

4. The method of claim 3 wherein said conditionally adjusted speed limit further includes the use of at least one legislatively adjusted speed limit, modified speed limit sign, lane speed limit sign, electronic speed limit sign, or multiple speed limit sign, alone or in combination.

5. The method of claim 4 wherein:
(a) said modified speed limit sign comprises at least one speed limit sign that displays two speed limits alone or in combination, and wherein at least one of said speed limits is a conditionally adjusted speed limit;
(b) said lane speed limit sign comprises at least one speed limit sign that displays at least one conditionally adjusted speed limit;
(c) said electronic speed limit sign comprises a changeable electronic messaging display means which displays at least one conditionally adjusted speed limit, and wherein said conditionally adjusted speed limit is used alone or in combination with at least one other piece of information selected from the group consisting of words, phrases, numbers, pictorial representations, vehicular restrictions, traffic conditions, traffic accidents, poor roadway conditions, smog levels, weather conditions, alternate routes, geographical information, advertising, slogans, exclusionary messages, class exclusionary messages, and emissive exclusionary messages, alone or in combination; and
(d) said multiple speed limit sign comprises at least one speed limit sign that displays at least three speed limits alone or in combination, and wherein at least one of said speed limits is a conditionally adjusted speed limit.

6. The method of claim 2 wherein said conditionally adjusted speed limit further includes the use of at least one legislatively adjusted speed limit, modified speed limit sign, lane speed limit sign, electronic speed limit sign, or multiple speed limit sign, alone or in combination.

7. The method of claim 6 wherein:
(a) said modified speed limit sign comprises at least one speed limit sign that displays two speed limits alone or in combination, and wherein at least one of said speed limits is a conditionally adjusted speed limit;
(b) said lane speed limit sign comprises at least one speed limit sign that displays at least one conditionally adjusted speed limit;
(c) said electronic speed limit sign comprises a changeable electronic messaging display means which displays at least one conditionally adjusted speed limit, and wherein said conditionally adjusted speed limit is used alone or in combination with at least one other piece of information selected from the group consisting of words, phrases, numbers, pictorial representations, vehicular restrictions, traffic conditions, traffic accidents, poor roadway conditions, smog levels, weather conditions, alternate routes, geographical information, advertising, slogans, exclusionary messages, class exclusionary messages, and emissive exclusionary messages, alone or in combination; and
(d) said multiple speed limit sign comprises at least one speed limit sign that displays at least three speed limits alone or in combination, and wherein at least one of said speed limits is a conditionally adjusted speed limit.

8. The method of claim 1 wherein said conditionally adjusted speed limit further includes the use of at least one legislatively adjusted speed limit, modified speed limit sign, lane speed limit sign, electronic speed limit sign, or multiple speed limit sign, alone or in combination.

9. The method of claim 8 wherein:
(a) said modified speed limit sign comprises at least one speed limit sign that displays two speed limits alone or in combination, and wherein at least one of said speed limits is a conditionally adjusted speed limit;
(b) said lane speed limit sign comprises at least one speed limit sign that displays at least one conditionally adjusted speed limit;
(c) said electronic speed limit sign comprises a changeable electronic messaging display means which displays at least one conditionally adjusted speed limit, and wherein said conditionally adjusted speed limit is used alone or in combination with at least one other piece of information selected from the group consisting of words, phrases, numbers, pictorial representations, vehicular restrictions, traffic conditions, traffic accidents, poor roadway conditions, smog levels, weather conditions, alternate routes, geographical information, advertising, slogans, exclusionary messages, class exclusionary messages, and emissive exclusionary messages, alone or in combination; and
(d) said multiple speed limit sign comprises at least one speed limit sign that displays at least three speed limits alone or in combination, and wherein at least one of said speed limits is a conditionally adjusted speed limit.

10. A modified speed limit sign comprising at least one speed limit sign that displays a first speed limit and a second speed limit alone or in combination, and wherein said first speed limit is a conditionally adjusted speed limit and said second speed limit is selected from the group consisting of conditionally adjusted speed limits, unadjusted speed limits, minimum speed limits, and combinations thereof.

11. The claim as recited in claim 10 wherein said modified speed limit sign further includes at least one vehicular restriction in order to thereby create a vehicular restricted modified speed limit sign.

12. The claim as recited in claim 10 wherein said modified speed limit sign further includes at least one additional speed limit selected from the group consisting of conditionally adjusted speed limits, unadjusted speed limits, minimum speed limits, and combinations thereof in order to thereby create a multiple speed limit sign.

13. The claim as recited in claim 12 wherein said multiple speed limit sign further includes at least one vehicular restriction in order to thereby create a vehicular restricted multiple speed limit sign.

14. A method of increasing the overall vehicular capacity of a conventional road comprising the utilization of at least one electronic speed limit sign to display at least one conditionally adjusted speed limit, and wherein said conditionally adjusted speed limit is used to control the speed limit of at least one lane of said conventional road so as to thereby create a roadway.

15. The method of claim 14 wherein said changeable electronic messaging display means further includes at least one other piece of information selected from the group consisting of words, phrases, numbers, pictorial representations, vehicular restrictions, traffic conditions, traffic accidents, roadway conditions, smog levels, weather conditions, alternate routes, geographical information, advertising, slogans, exclusionary messages, class exclusionary messages, and emissive exclusionary messages, alone or in combination.

16. The method of claim 15 wherein the information displayed on said electronic speed limit sign is controlled in an automatic, semi-automatic or manual manner by at least one computer using one or more means selected from the group consisting of telephones, cellular telephones, radios, microwave devices, internet devices, satellites, electrical, and electronic means, alone or in combination, and wherein said electronic speed limit sign is powered by at least one electric power utility, portable electric generator, fuel cell, battery, or array of photovoltaic solar cells, alone or in combination.

17. The method of claim 16 wherein the control of vehicular traffic by said computer is further enhanced by the use of one or more vehicular sensing, vehicular counting, vehicular tolling, temperature sensing, wind measuring, precipitation sensing, light sensing, smog sensing, and camera devices, alone or in combination.

18. The method of claim 15 wherein the control of vehicular traffic by said computer is further enhanced by the use of one or more vehicular sensing, vehicular counting, vehicular tolling, temperature sensing, wind measuring, precipitation sensing, light sensing, smog sensing, and camera devices, alone or in combination.

19. The method of claim 14 wherein the information displayed on said electronic speed limit sign is controlled in an automatic, semi-automatic or manual manner by at least one computer using one or more means selected from the group consisting of telephones, cellular telephones, radios, microwave devices, internet devices, satellites, electrical, and electronic means, alone or in combination, and wherein said electronic speed limit sign is powered by at least one electric power utility, portable electric generator, fuel cell, battery, or array of photovoltaic solar cells, alone or in combination.

20. The method of claim 19 wherein the control of vehicular traffic by said computer is further enhanced by the use of one or more vehicular sensing, vehicular counting, vehicular tolling, temperature sensing, wind measuring, precipitation sensing, light sensing, smog sensing, and camera devices, alone or in combination.
